(19) United States
(12) Patent Application Publication
(10) Pub. No.: US 2002/0145774 A1
(43) Pub. Date: Oct. 10, 2002

(54) Telecommunications switch using a Laser-CRT to switch between multiple optical fibers

(76) Inventor: Glenn H. Sherman, Del Mar, CA (US)

Correspondence Address: LAW OFFICES OF JAMES D. MCFARLAND, 12555 HIGH BLUFF DRIVE, SUITE 305, SAN DIEGO, CA, 92130, US

(21) Appl. No.: 10/094,249

(22) Filed: Mar. 8, 2002

Related U.S. Application Data
(60) Provisional application No. 60/274,116, filed on Mar. 8, 2001.

(51) Int. Cl. G02F 1/00

(52) U.S. Cl. 359/109

(57) ABSTRACT

A telecommunications switch system utilizes a laser cathode ray tube (Laser-CRT) including a faceplate having a plurality of laser pixels. A driver and control system control an electron beam to energize a selected laser pixel and thereby provide laser emission from the selected laser pixel. The laser emission from each pixel (an optical signal) is provided to an optical distribution system such as a plurality of optical fibers that directs the laser emission to one of a plurality of destinations. The faceplate can have multiple groups of laser pixels, each group providing a different wavelength. In some embodiments the Laser-CRT includes a plurality of electron guns. Some embodiments include an optical multiplexer that multiplexes a number of optical signals into a single optical fiber (N:1). Alternative switch configurations are disclosed, such as an optical-to-optical switch. The Laser-CRT system can be implemented to meet a variety of needs, such as optical switching, DWDM, and optical signal regeneration.

### CROSS-REFERENCE TO RELATED APPLICATION

Priority is hereby claimed to U.S. application Ser. No. 60/274,116, filed Mar. 8, 2001, entitled TELECOMMUNICATIONS SWITCH USING A LASER-CRT TO SWITCH BETWEEN MULTIPLE OPTICAL FIBERS by the same inventor, which is incorporated by reference herein.

### BACKGROUND OF THE INVENTION

1. Field of the Invention

This invention relates to optical telecommunications systems, and particularly to optical fiber switches.

2. Description of Related Art

The telecommunications industry has been rapidly growing as a result of the ever-increasing demand for bandwidth to support more bandwidth-intensive operations. Communications networks that twenty years ago relied almost exclusively upon wire connections are now being converted to optical fiber networks. Optical fibers can carry far more signals than wire. Accordingly, optical fiber networks currently form an important part of telecommunication networks, and will play a key role in the future.

Optical fibers carry a large amount of information in the form of modulated light signals. In order to create a practical communications network, it is essential that the light signals be switched in order to route the signal from the sender to the correct recipient. Such applications may require that a single signal on a single line be switched to any of a number of optical fibers in accordance with routing instructions contained in the signal. Thus, there is a need for a fast, efficient, and reliable optical switching system.

For long distance fiber optic links, it may be essential to regenerate the optical signal at regular distance intervals due to physical effects such as attenuation and dispersion. Accordingly, there is a need for an efficient and reliable optical-to-optical converter.

DWDM systems have been developed to carry large amounts of information. In a DWDM system, modulated laser emissions at a number of closely-spaced wavelengths are multiplexed into a single optical fiber. At the receiving end the wavelengths are separated to recover each signal. For DWDM systems, there is a need for a modulator that can efficiently and reliably modulate the signals at a plurality of DWDM wavelengths in such a way that they can be combined into an optical fiber for DWDM communications.

### SUMMARY OF THE INVENTION

A telecommunications switch system is disclosed that utilizes a laser cathode ray tube (Laser-CRT) to select a laser pixel from a plurality of pixels on the faceplate. The laser radiation emitted from the pixels is coupled into an optical distribution system that distributes the optical signals to a plurality of destinations. In one embodiment the laser emission from each pixel is coupled into an associated optical fiber of a plurality of optical fibers, thereby directing an optical signal to propagate along the optical fiber associated with the selected laser pixel to a predetermined destination. Advantages include low-cost, high modulation speed, high energy efficiency, and reliable operation. The Laser-CRT can be implemented to meet a variety of needs, such as optical switching, DWDM, and optical signal regeneration.

A telecommunications switch is described herein that comprises a Laser-CRT including an electron gun that generates an electron beam and a laser faceplate arranged to receive the electron beam. The laser faceplate includes a plurality of laser pixels that emit laser radiation in response to being energized by the electron beam. The emitted laser radiation is provided to an optical distribution system, which in one embodiment comprises a plurality of optical fibers. A driver and control system is provided to control the electron beams to energize a selected laser pixel and thereby provide a laser emission from the selected laser pixel, which is then directed to a predetermined destination by the optical distribution system. In some embodiments the Laser-CRT comprises a plurality of electron guns that simultaneously generate a respective plurality of electron beams arranged to energize a plurality of pixels on the faceplate.

Embodiments are disclosed in which a plurality of optical fibers are optically coupled to the plurality of laser pixels. To optically couple the laser emission from the faceplate to the optical fiber, a microlens array may be situated adjacent to the faceplate.

In some embodiments the electron gun can move the electron beam randomly to any multitude of positions, in a way similar to how it is done in standard calligraphic CRTs, and each position (pixel) on the faceplate can have a separate optical fiber associated with it. The number of positions (optical fibers) attached to the faceplate is determined by design considerations such as the size of the laser beam, the ability to closely position the fibers, and cross talk specifications. In principle, there could be millions of laser pixels and associated optical fibers.

In some embodiments the telecommunications switch comprises a first group of pixels that emit a first wavelength and a second group of pixels that emit a second wavelength different from the first wavelength. Generally, the faceplate can have multiple groups of laser pixels, each group for example providing closely-separated wavelengths suitable for DWDM uses, or widely-separated wavelengths suitable for other telecommunications applications such as 880, 1330, or 1550 nm.

Some embodiments include an optical multiplexer that multiplexes a number of different wavelength signals onto a single optical fiber (N:1), which can be useful for DWDM and other telecommunications purposes. Such an embodiment can be extended to multiplex a large number (e.g. 200) of signals onto a single optical fiber using multiple electron guns subject to practical considerations such as how closely electron guns can be spaced, crosstalk specifications, and the acceptable complexity of the multiplexer.

Additional switch configurations are disclosed, such as an optical-to-optical switch, in which an optical information signal is first converted to an electrical signal by a suitable converter such as a photo detector, and then the converted electrical signal is applied to the electrical-to-optical converter.

### BRIEF DESCRIPTION OF THE DRAWINGS

For a more complete understanding of this invention, reference is now made to the following detailed description of the embodiments as illustrated in the accompanying drawing, wherein:

FIG. 1 is a diagram of a telecommunications switch including a cross-sectional view of a Laser-CRT that has a plurality of optical fibers coupled to the faceplate;

FIG. 2 is a cross-sectional view of one example of a faceplate of a Laser-CRT; showing a plurality of optical fibers and a fiber coupler array arranged to receive the light emitted from the faceplate and couple it into the optical fibers;

FIG. 3 is a diagram of an embodiment of a multiple input telecommunications switch (M×N switch) that includes multiple electron guns;

FIG. 4 is a diagram of an embodiment of a Laser-CRT that has a faceplate implemented to provide a plurality of groups of laser pixels;

FIG. 5 is a block diagram of one example of a DWDM system; and

FIG. 6 is a block diagram of an optical-to-optical switch that includes a Laser-CRT.

### DETAILED DESCRIPTION

This invention is described in the following description with reference to the Figures, in which like numbers represent the same or similar elements.

Glossary of Terms and Acronyms

The following terms and acronyms are used throughout the detailed description:

CRT: Cathode Ray Tube

DWDM: Dense Wavelength Division Multiplexer

DWDM wavelengths: A set of closely-spaced wavelengths (e.g. separated by 1-3 nanometers) used for DWDM communications.

Overview

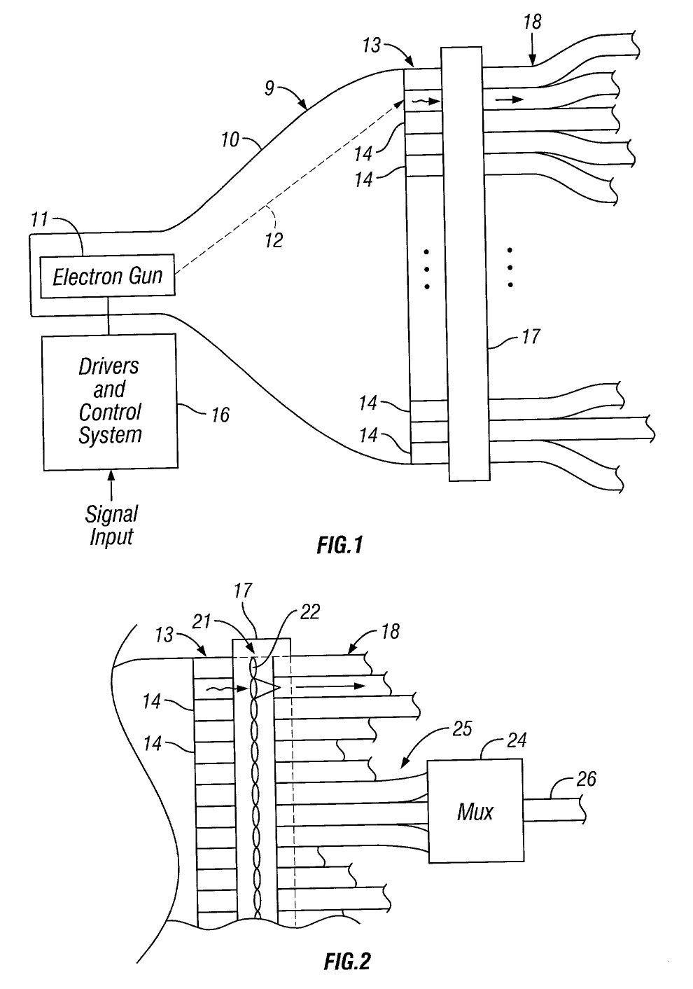

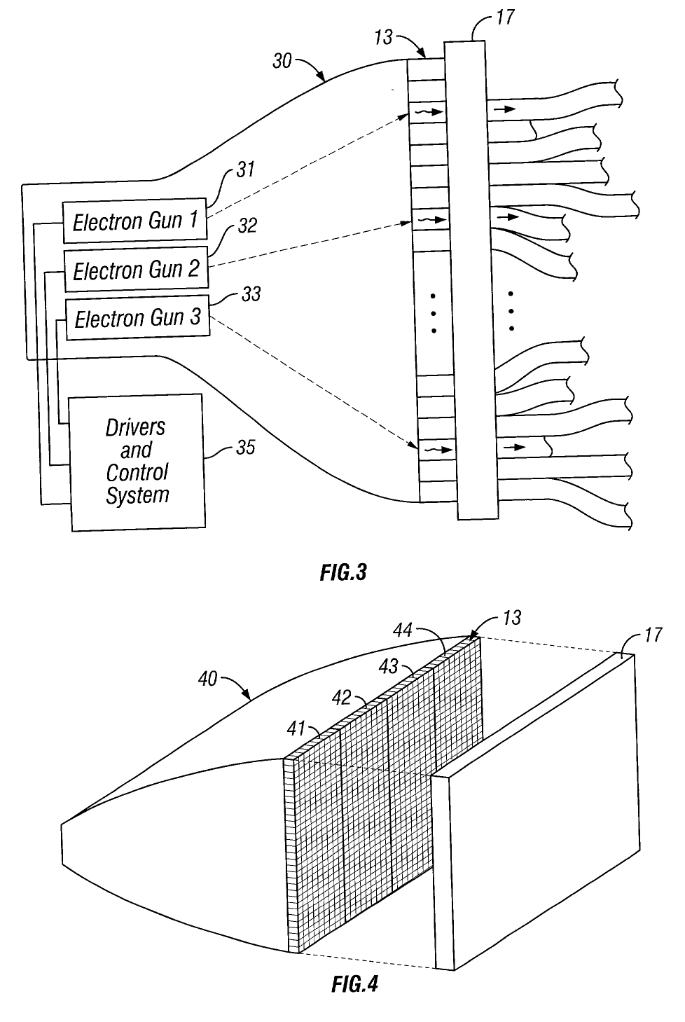

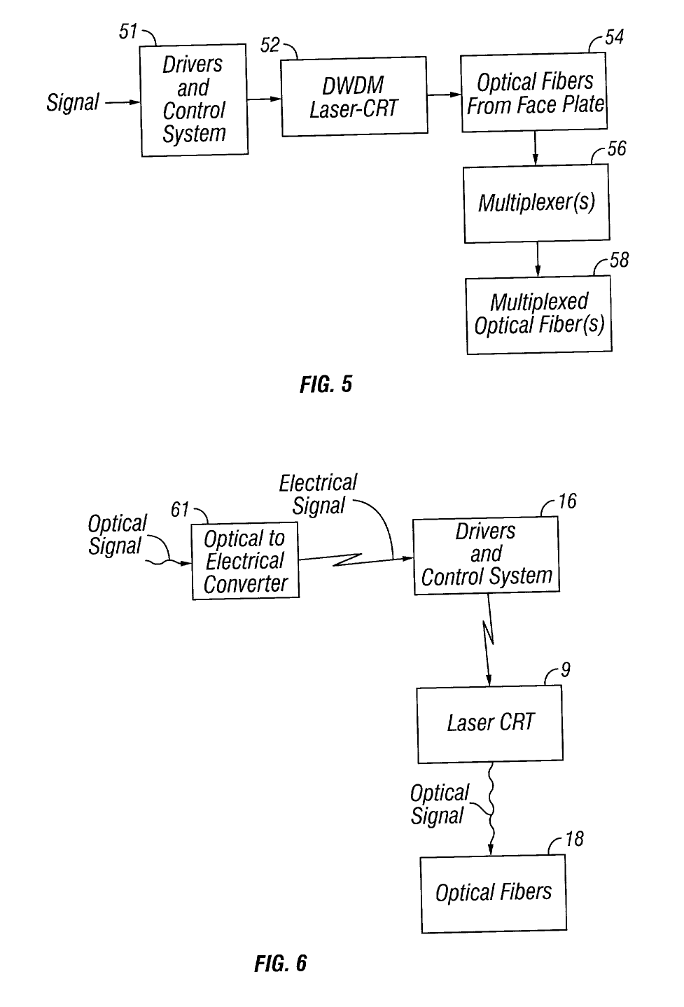

The telecommunications switch described herein can be utilized in a variety of different applications and devices, such as those discussed below. One device is an electrical-to-optical converter and switch (1×N switch) such as described with reference to FIG. 1, another device is a multiple input switch such as described with reference to FIG. 3, still another device is a dense wavelength division multiplexer (DWDM) switch such as described with reference to FIGS. 4 and 5, and another device is an optical-to-optical switch such as described with reference to FIG. 6.

A basic embodiment is an electrical-to-optical converter and switch, such as disclosed in FIG. 1, in which an information signal in an electrical form is converted into an optical form. In this basic embodiment, the electrical signal is fed to the input of the Laser-CRT where it controls an electron beam (e-beam) so that the electron beam carries the information. The electron beam strikes the laser faceplate, exciting laser action, and now the laser beam carries the information as an optical signal. In some embodiments an optical fiber is positioned to receive the emitted laser beam, and then the laser beam, which carries the optical signal, is propagated to a remote location or other destination as desired. In alternative embodiments, the emitted laser beam is not coupled into an optical fiber, but instead is propagated through air to another device or location.

Electric-to-optical converter (1×N switch)

FIG. 1 illustrates an example of an electric-to-optical converter and switch, in which an information signal in an electrical form is converted into an optical form. In the diagram of FIG. 1, the telecommunications switch includes a Laser-CRT 9, electrical drivers and control system 16 that receives a signal input and controls the Laser-CRT in response thereto. In the embodiment of FIG. 1, a fiber coupler array 17 receives the laser emission from the Laser-CRT 9 and couples it into a plurality of optical fibers 18. The optical fibers provide an optical distribution system that individually directs the output of each pixel to a predetermined destination, (e.g. any appropriate location or device). Using the optical distribution system, the optical signals originating from a single faceplate can be propagated to a wide variety of destinations; for example, a first fiber may be connected to the local telephone company, a second fiber may be connected to a wireless cellular network, third and fourth fibers can be multiplexed together, and a fifth fiber may be used to provide a long distance fiber optic communication link.

FIG. 1 includes a cross-sectional view of the Laser-CRT 9. The Laser-CRT comprises a vacuum tube 10, an electron gun 11 that emits an electron beam 12, and a laser screen (faceplate) 13 that includes a grid of laser pixels 14 designed to emit laser radiation in response to pump excitation by the electron beam. Particularly, under control of the electrical drivers and related control circuitry 16, the electron gun 11 generates a beam of electrons 12 that can be focused by the electron gun onto each pixel on the laser faceplate, and varied in position and intensity. Thus, the Laser-CRT operates by directing the electron beam to selectively energize one or more of a plurality of laser pixels defined in the faceplate. The laser pixels are defined on the faceplate in any suitable manner; for example the faceplate may comprise a plurality of separate laser components, one for each pixel. Alternatively, the faceplate may comprise a continuous laser structure in which the pixels are defined by the locations energized by the electron beam; for example a shadow mask can be placed between the faceplate and the electron gun to allow the electron beam to energize only the specific locations accessed through the gaps in the shadow mask, similar to those used in color TV CRTs. Examples of a Laser-CRT are disclosed in U.S. Pat. Nos. 5,254,502, 5,280,360, 5,283,798, 5,313,483, 5,317,583, 5,339,003, 5,374,870, 5,687,185, and in Basov et al., “Laser Cathode-Ray Tubes Using Multilayer Heterostructures,” Laser Physics Vol. 6 No. 3, 1996, pp. 608-611.

To provide a telecommunications switch using the Laser-CRT, the faceplate 13 of the Laser-CRT is coupled to an optical distribution system. In the embodiment of FIG. 1, the optical distribution system comprises a plurality of optical fibers; in alternative embodiments other propagation systems may be used; for example the laser radiation emitted from the pixel can be propagated through air to another device or location. In the optical fiber embodiment of FIG. 1, the faceplate is situated in close proximity to the fiber coupler array 17, and is connected to the plurality of optical fibers 18 so that the laser emission from each laser pixel is coupled to an associated optical fiber, which then transmits the coupled-in optical signal to its desired destination. Any suitable fiber optic coupling system can be used to couple the light from the laser pixels into the optical fiber, such as a lens array shown in FIG. 2, which couples the light from the pixels by concentrating it in the optical fibers.

In one embodiment the electron beam 12 can be controlled by the electrical drivers and control system 16 using calligraphic techniques to arbitrarily address any selected laser pixel on the faceplate responsive to the signal input into the electrical drivers and control system. Thus, by using scanning calligraphic techniques to control the electron beam rather than scanning techniques, any of the laser pixels can be addressed individually, and the laser light generated in that particular pixel is coupled into its associated optical fiber. The light signals coupled into the optical fibers are then propagated along the optical fibers to their respective destinations.

In order to provide a suitable output wavelength for the desired use, the laser pixels on the faceplate of the Laser-CRT are implemented with an appropriate laser material. For example, for some telecommunications uses, the faceplate could be manufactured to provide an output wavelength of about 0.9 microns, or 1.3 microns, or 1.5 microns, which are typical wavelengths used in fiber optic telecommunications networks. Thus a great deal of flexibility to choose wavelength can be achieved by varying the wavelength emitted by the pixels; for example in some embodiments pixels on the same faceplate can be designed to emit different wavelength, such as described with reference to FIG. 4. These different wavelengths may be large (e.g. 880 nanometers, 1330 nanometers and 1550 nanometers) or incremental (e.g. 1550 nanometers to 1570 nanometers in steps of two nanometers). Using an optical multiplexer (such as shown in FIG. 2) these different wavelengths could then be coupled into a single fiber.

FIG. 2 is a cross-sectional view of one example of the faceplate 13, the fiber coupler 17, and the optical fibers 18. In this example the fiber coupler comprises a microlens array 21 situated between the faceplate and the plurality of optical fibers. The microlens array includes a plurality of lenses 22 arranged to focus the laser light from each pixel onto the end of an associated optical fiber.

FIG. 2 also shows an optical multiplexer 24 that couples the optical signals from a group of optical fibers into a single optical fiber 26. The optical multiplexer may be useful, for example, to couple different wavelengths into a single optical fiber. In the example of FIG. 2, a 3:1 multiplexer is shown; in other embodiments any desired number of optical signals can be multiplexed into a single optical fiber, for example 2:1, or 4:1, or in general N:1, where N is the number of optical fibers input to the multiplexer. Any suitable optical multiplexer can be used. In alternative embodiments, the optical fiber coupling may be omitted, thereby air-coupling the laser radiation (using any suitable optics) from the faceplate to the multiplexer using for example any suitable optics.

Multiple input electric-to-optical converter (M×N switch)

FIG. 3 is diagram of an embodiment of a multiple input telecommunications switch (M×N switch) that includes multiple electron guns, each of which is controlled separately to provide an optical communication link. Particularly, FIG. 3 shows a Laser-CRT 30 that includes three electron guns 31, 32, and 33. Each of the electron guns can be separately controlled by the electrical drivers and control system 35. In the multiple input telecommunications switch shown in FIG. 3, the multiple electron beams can operate in parallel to energize multiple laser positions on the faceplate to provide parallel communication links. Thus, by utilizing multiple electron guns, a system is provided in which multiple electrical inputs each have their own separate electron beam and controls within a single CRT analogous to the three electron beams in a color TV used to generate red, green, and blue. In some embodiments, the electrical drivers and control system 35 may utilize calligraphic techniques to arbitrarily address any selected laser pixel on the faceplate responsive to a signal input into the electrical drivers and control system.

In alternative embodiments a different number of electron guns may be implemented. Particularly, although FIG. 3 shows three electron guns, the concept of using multiple guns could be extended to embodiments with more than three electron guns, each electron gun providing one output beam. The number of electron guns (M) may be large (e.g. 200 or more), and is limited only by practical considerations such as how closely the electron guns could be spaced so that the beam from each could access the entire faceplate. In one embodiment, miniature electron emitters such as those used in plasma displays could be used to allow a large number of electron guns to be included in a single display.

DWDM converter

Reference is now made to FIGS. 4 and 5. FIG. 4 is a diagram of one embodiment of a Laser-CRT 40 that has a faceplate implemented to provide two or more groups of laser pixels and associated optical fibers, each group providing a different wavelength suitable for DWDM uses. In FIG. 4, the multi-group faceplate includes four different groups of pixels including a first group 41, a second group 42, a third group 43, and a fourth group 44, for purposes of illustration of this concept. It should be apparent that in other embodiments a different number of groups can be implemented, each with a different wavelength; for example in one DWDM system the faceplate may have 200 different groups with wavelengths separated by about 1-3 nm. Furthermore, in some embodiments, each group could consist of only one pixel; that is, the multi-group faceplate in such embodiments would have N pixels, each pixel outputting a different laser wavelength. In addition to the multi-group faceplate, in some embodiments the Laser-CRT 40 comprises multiple electron guns such as described with reference to FIG. 3. In alternative embodiments, the groups of laser pixels shown in FIG. 4 could provide widely-separated wavelengths suitable for telecommunications purposes, for example, 880, 1330, or 1550 nm.

FIG. 5 is a block diagram of one example of a DWDM system. In FIG. 5, a signal is applied to electrical drivers and control system 51, which includes appropriate circuitry to drive a Laser-CRT 52 responsive to the applied signal. In the embodiment of FIG. 5, the Laser-CRT 52 includes a multi-group faceplate such as discussed with reference to FIG. 4, and also includes multiple electron guns, such as discussed with reference to the Laser-CRT 30 in FIG. 3. In this embodiment, the modulated output from the faceplate is coupled into a plurality of optical fibers 54, and then the optical fibers are multiplexed in one or more multiplexers 56 to combine multiple optical signals, (i.e. combine multiple wavelengths) into optical fiber(s) 58.

In FIG. 5, the multi-group faceplate on the Laser-CRT 52 includes a plurality of groups suitable for the DWDM application. Each group on the faceplate emits a discrete wavelength within a DWDM range of wavelengths; advantageously, the information signal can be converted to any of the available wavelengths by selecting the laser pixel associated with that wavelength. The number of groups (and accordingly the number of wavelengths) varies between implementations. For example, in one embodiment of a 1:10 DWDM switch, the faceplate includes ten groups, each group provides one of the ten discrete wavelengths, and the wavelengths are separated by about 1-3 nm. In operation, a single signal can be switched between the ten different wavelengths by selecting the laser pixel(s) in the group associated with the desired output wavelength.

The multiple electron guns in the Laser-CRT 52 are useful to simultaneously energize multiple laser pixels (e.g. for modulating in parallel), as in the multiple input electric-to-optical converter discussed with reference to FIG. 3. Calligraphic techniques may be used to arbitrarily address any selected laser pixel on the faceplate responsive to a signal input into the electrical drivers and control system. In some embodiments, each electron gun in the Laser-CRT is assigned to selectively energize the pixels within a particular group; e.g., a first electron gun is assigned to energize pixels in the first group, and so forth.

The output light emitted from each pixel in each group is coupled into an optical fiber. The typically large number of pixels in a Laser-CRT requires a correspondingly large number of optical fibers 54. For many applications, it may be advantageous to combine (i.e. multiplex) the output light from the large number of fibers 54 from the faceplate into a much smaller number of fibers. For this purpose, one or more optical multiplexers 56 are arranged to receive the output light signals from N of the optical fibers 54, and multiplex them into a single optical fiber (N:1). Such a multiplexer is described with reference to the multiplexer 24 in FIG. 2.

In one embodiment, the multiplexers 56 include a plurality of N:1 optical multiplexers, and an optical fiber from each faceplate group is input into each of the N:1 optical multiplexers. By controlling the Laser-CRT to select the laser pixel from the group with the desired wavelength, and modulating that selected pixel with the desired signal, a modulated signal with a selected wavelength is coupled into the single optical fiber at the output of the multiplexer. In one example, an optical fiber from a pixel in each of ten different groups in the faceplate is combined in a 10:1 multiplexer so that any or all of the ten different wavelength signals can be propagated along the single fiber at the output of the multiplexer. In alternative embodiments, the optical fibers 54 may be omitted, and instead an air-coupling (and appropriate optics) may be used to couple the laser radiation from the faceplate of the Laser-CRT 52 to the multiplexer 56.

Optical-to-optical switch

The Laser-CRTs described herein can be used in a variety of configurations, to provide a variety of switches. One example is shown in FIG. 6, which is an optical-to-optical switch. In FIG. 6, the switch includes a suitable optical-to-electrical converter 61, such as a photodetector, that receives a modulated optical signal from any optical source, such as an optical fiber or a directed optical beam. In the optical-to-electrical converter 61, the optical signal is converted to an electrical signal, and then the converted electrical signal is utilized by the electrical drivers and control system 16 (FIG. 1) to control the Laser-CRT 9 to output a modulated optical signal which is then coupled into the optical fibers 18. The pixel to be energized may be selected responsive to routing information included in the signal itself. Such a system can be useful for uses such as routing information on a single optical fiber to one or more other optical fibers. Furthermore, such a system can be useful for regeneration of optical signals in long distance optical fiber links.

It will be appreciated by those skilled in the art, in view of these teachings, that alternative embodiments may be implemented without deviating from the spirit or scope of the invention. This invention is to be limited only by the following claims, which include all such embodiments and modifications when viewed in conjunction with the above specification and accompanying drawings.

What is claimed is:

1. A telecommunications switch comprising:
a Laser-CRT including
an electron gun that generates an electron beam and
a laser faceplate arranged to receive said electron beam, said faceplate comprising a plurality of laser pixels that emit laser radiation in response to being energized by said electron beam;
an optical distribution system optically coupled to said plurality of laser pixels, said optical distribution system directing the laser emission from each of said plurality of pixels to one of a plurality of destinations; and
a control system for controlling said electron beams to energize a selected laser pixel and thereby provide an optical signal from said selected pixel to the destination associated with said selected pixel.

2. The telecommunications switch of claim 1, wherein said optical distribution system includes a plurality of optical fibers respectively coupled to said plurality of laser pixels.

3. The telecommunications switch of claim 2, further comprising a microlens array arranged adjacent to said faceplate to couple said laser radiation from said faceplate into said plurality of optical fibers.

4. The telecommunications switch of claim 1, further comprising a plurality of electron guns that simultaneously generate a respective plurality of electron beams arranged to energize a plurality of pixels on said faceplate.

5. The telecommunications switch of claim 1, wherein said faceplate comprises a plurality of groups of pixels.

6. The telecommunications switch of claim 5, further comprising a plurality of groups of pixels including a first group of pixels that emit a first wavelength and a second group of pixels that emit a second wavelength different from said first wavelength.

7. The telecommunications switch of claim 1, further comprising an N:1 optical multiplexer coupled to said optical distribution system to receive the optical signals emitted from N of said pixels.

8. The telecommunications switch of claim 1, further comprising a system for converting an input optical signal into an output optical signal, including an optical-to-electrical converter that receives said input optical signal and converts it to an electrical signal, and a driver and control circuit that receives said electrical signal and controls said electron gun responsive thereto.

9. A multiple wavelength telecommunications switch, comprising:
a Laser-CRT including
an electron gun that generates an electron beam, and
a laser faceplate comprising a plurality of laser pixels that emit laser radiation in response to said electron beam, said plurality of laser pixels defining a plurality of groups including a first group that emits a first wavelength and a second group that emits a second, different wavelength;
optical distribution means, optically coupled to said plurality of pixels, for directing the laser emission from each of said plurality of pixels to one of a plurality of destinations; and
a control system for controlling said one or more electron beams to energize selected laser pixels and thereby provide optical signals to the respective destinations associated with said selected laser pixels.

10. The multiple wavelength telecommunications switch of claim 9, wherein said optical distribution means includes a plurality of optical fibers respectively coupled to said plurality of laser pixels.

11. The multiple wavelength telecommunications switch of claim 9 wherein said laser pixels comprise N groups, and further comprising an N:1 multiplexer arranged so that the optical output of a pixel from each group is coupled to the input of said multiplexer.

12. The multiple wavelength telecommunications switch of claim 9 wherein said plurality of groups of pixels respectively define DWDM wavelengths, thereby providing a DWDM switch.

13. The multiple wavelength telecommunications switch of claim 9, further comprising a plurality of electron guns that simultaneously generate a respective plurality of electron beams arranged to energize a plurality of pixels on said faceplate.

14. The multiple wavelength telecommunications switch of claim 9 wherein said optical distribution system comprises a plurality of optical fibers optically coupled to said plurality of laser pixels.

15. The multiple wavelength telecommunications switch of claim 9 wherein said laser pixels comprise N groups, and further comprising an N:1 multiplexer arranged with the optical distribution system so that an optical signal from each group is coupled to the input of said multiplexer.

16. The multiple wavelength telecommunications switch of claim 15 further comprising a plurality of N:1 multiplexers arranged with the optical distribution system so that an optical signal from each group is coupled to the input of each of said multiplexers.

17. A DWDM telecommunications switch, comprising:
a Laser-CRT including
a plurality of electron guns that generate a respective plurality of electron beams, and
a laser faceplate arranged to receive said electron beams, said faceplate comprising a plurality of laser pixels that emit laser radiation in response to energization by said electron beams, said plurality of laser pixels defining a plurality of groups corresponding to DWDM wavelengths including a first group that emits a first DWDM wavelength and a second group that emits a second DWDM wavelength;
an optical distribution system optically coupled to said plurality of laser pixels, said optical distribution system directing the laser emission from each of said plurality of pixels to one of a plurality of destinations; and
a control system for controlling said one or more electron beams to energize selected laser pixels and thereby provide optical signals to the respective destinations associated with said selected laser pixels.

18. The telecommunications switch of claim 17, wherein said optical distribution system includes a plurality of optical fibers respectively coupled to said plurality of laser pixels.

19. The DWDM telecommunications switch of claim 18, further comprising a microlens array arranged adjacent to said faceplate to couple said laser radiation from said faceplate into said plurality of optical fibers.

20. The DWDM telecommunications switch of claim 17, wherein said plurality of groups include comprise N groups, and further comprising an N:1 multiplexer arranged so that an optical signal from each group is coupled to the input of said N:1 multiplexer.

21. The DWDM telecommunications switch of claim 17 wherein each of said plurality of electron guns is associated with a respective one of said plurality of groups.

22. The DWDM telecommunications switch of claim 17, further comprising a system for converting an input optical signal into an output optical signal, including an optical-to-electrical converter that receives said input optical signal and converts it to an electrical signal, and a driver and control circuit that receives said electrical signal and controls said electron guns responsive thereto.

23. A method of providing a modulated optical signal comprising:
selecting a pixel of a faceplate of a Laser-CRT;
electrically modulating an electron gun in the Laser-CRT to generate modulated laser radiation from the pixel; and
coupling the modulated laser radiation into an optical fiber.

24. The method of claim 23 further comprising:
selecting a plurality of pixels of faceplate of the Laser-CRT;
electrically modulating the electron gun in the Laser-CRT to generate modulated laser radiation from said selected pixels; and
coupling the modulated laser radiation from said selected pixels into a plurality of optical fibers.

25. The method of claim 24 further comprising multiplexing said modulated laser radiation from said plurality of fibers into an optical fiber.

26. The method of claim 24 further comprising generating modulated laser radiation having a plurality of DWDM wavelengths.

27. A method for switching a modulated optical signal between a plurality of destinations, comprising:
selecting a plurality of pixels of a faceplate of a Laser-CRT;
electrically modulating one or more electron guns in the Laser-CRT to generate modulated laser radiation from said selected pixels; and
directing the modulated laser radiation from each of said selected pixels to a respective destination associated with said respective pixel.

28. The method of claim 27 further comprising generating modulated laser radiation having a plurality of DWDM wavelengths.

29. The method of claim 27 further comprising directing modulated laser radiation from at least two of said selected pixels to a multiplexer, and multiplexing said modulated laser radiation from said at least two pixels into an optical fiber.

30. The method of claim 27 further comprising coupling the modulated laser radiation from said selected pixels into a plurality of optical fibers respectively coupled to said pixels.

31. The method of claim 27 further comprising:
coupling a first optical signal emitted from a first selected pixel into a first optical fiber, and propagating said first optical signal along said optical fiber to a first destination; and
coupling a second optical signal emitted from a second selected pixel into a second optical fiber, and propagating said second optical signal along said optical fiber to a second destination.

32. The method of claim 31 wherein said first selected pixel emits laser radiation having a first wavelength, and said second selected pixel emits laser radiation having a second, different wavelength.
